(19) United States
(12) Patent Application Publication
(10) Pub. No.: US 2002/0152461 A1
(43) Pub. Date: Oct. 17, 2002

(54) Coordination of favorites among disparate devices in an interactive video casting system

(76) Inventor: Anthony F. Istvan, Snoqualmie, WA (US)

Correspondence Address: Dennis M. de Guzman, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/919,605

(22) Filed: Jul. 30, 2001

Related U.S. Application Data
(63) Continuation-in-part of application No. 09/895,861, filed on Jun. 28, 2001.
(63) Continuation-in-part of application No. 09/895,880, filed on Jun. 28, 2001.
(63) Continuation-in-part of application No. 09/895,879, filed on Jun. 28, 2001.
(60) Provisional application No. 60/267,215, filed on Feb. 7, 2001.

(51) Int. Cl. H04N 7/10; H04N 7/173; H04N 7/025

(52) U.S. Cl. 725/32; 725/134; 725/109

(57) ABSTRACT

Coordination of favorites, such as web favorites, among disparate devices is performed via use of a user model for an interactive video casting system. The user model organizes access devices into households, with each access device in a household being logical extensions of each other. Each household can have multiple user objects, with each user object having its own independent configuration of attributes and data (such as web favorites). Other access devices (if any) in the household automatically receive the information of a new or reconfigured user object (such as revised favorites settings) without any further action by the user. When a user adds a new access device to the household, the new access device automatically receives the user object information of user objects, including favorites settings, already existing in the household, without any further action by the user.

### CROSS-REFERENCE TO RELATED APPLICATIONS

The present application claims the benefit of and is a continuation-in-part of U.S. patent application Ser. No. 09/895,861, entitled “USER MODEL FOR INTERACTIVE TELEVISION SYSTEM,” filed Jun. 28, 2001; U.S. patent application Ser. No. 09/895,880, entitled “INFORMATION ACCESS IN USER MODEL-BASED INTERACTIVE TELEVISION,” filed Jun. 28, 2001; and U.S. patent application Ser. No. 09/895,879, entitled “ACCESS DEVICE INTERFACE FOR USER MODEL-BASED INTERACTIVE TELEVISION,” filed Jun. 28, 2001, all of which claim priority based on U.S. Provisional patent application Ser. No. 60/267,215, entitled “USER MODEL FOR INTERACTIVE TELEVISION SYSTEM,” filed Feb. 7, 2001. All of these priority applications are incorporated herein by reference in their entirety.

### TECHNICAL FIELD

This disclosure relates generally to interactive video casting systems, and in particular but not exclusively, relates to coordination of favorites among disparate access devices (e.g., client terminals) having connectivity to an interactive video casting system, such as in an interactive television system.

### BACKGROUND

Televisions and Internet technologies are beginning to converge. For example, the Internet is gaining television-like qualities, such as the capability to play videos and music, and to broadcast live video feeds. In a similar manner, televisions are becoming more interactive like the Internet. In particular, access to the World Wide Web (or simply the “web”) via Internet-enabled television systems is progressing and becoming more popular. Such television systems allow users to access both web content information and television content information from a single system. In short, users can now “surf the web” via their televisions.

Conventional systems typically use a set top box (STB) to provide access to the interactive television system. These systems tend to treat each STB as an independent unit. These systems are disadvantageous in various aspects. First, they typically allow only primitive configuration functions. Second, they typically do not provide convenient support across multiple access devices. Third, they typically do not provide convenient support across multiple applications and services.

This dilemma becomes more pronounced in situations where a user enters or sets “favorites” in an interactive television system. As is known with conventional web browsers for personal computers (PCs), a user can bookmark/save favorite or commonly accessed uniform resource locator (URL) addresses of web sites as a shortcut technique, so as to avoid the need to re-enter long URL addresses or to search for a URL address each time the user wishes to access that address. For PC browsers and for analogous software used by STBs, favorites need to be set by the user for each particular STB that is to access the Internet.

While this may not present great inconvenience in a household where there is only one user and only one STB, the same thing cannot be said in situations where there are multiple users and/or multiple access devices in the same household that are capable of accessing the Internet via the interactive television system. For instance, in addition to separate STBs in each bedroom, there may be PCs, laptops, pagers, cellular telephones, wireless devices, and the like that are capable of interaction with the interactive television system. In such situations, the favorites typically will need to be separately set for each and every device for a particular user. Moreover, whenever the user updates/revises the list of favorites for one device, each of the other devices will need to be correspondingly and separately updated by the user in order for the updated favorites to be available to all devices.

This can be extremely inconvenient and impractical if there is a large number of favorites that need to be set by the user in each device. One can imagine the frustration that a user may experience when turning on one of these devices and then realizing that his favorites are not set for that particular device because he forgot to copy the favorites from another device. The inconvenience and impracticality of having to separately set favorites for each device multiplies if there are multiple users in the same household that share some of the same devices and each of the users have different favorites that they wish to set and access. In fact, given existing configurations, it may not even be possible for some of the devices to accommodate more than one list of favorites.

Accordingly, improvements are needed in coordination of favorites or other settings among disparate access devices in an interactive video casting system.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a simplified diagram illustrating an interactive television system according to one embodiment of the present invention.

FIG. 2 is a block diagram illustrating a client system according to one embodiment of the present invention.

FIG. 3 is a block diagram illustrating an example access device according to one embodiment of the present invention.

FIG. 4 is a diagram illustrating an example control device according to one embodiment of the present invention.

FIG. 5 is a logical object diagram illustrating a single household user model according to one embodiment of the present invention.

FIG. 6 is a logical object diagram illustrating a multi-household user model according to one embodiment of the present invention.

FIG. 7 is a diagram illustrating components of a logical object according to one embodiment of the present invention.

FIG. 8 is a diagram illustrating components of a user object according to one embodiment of the present invention.

FIG. 9 is a flow diagram illustrating the operational flow in using a user model as depicted in FIG. 5 according to one embodiment of the present invention.

FIG. 10 is a flow diagram illustrating the addition a new user object to a household according to one embodiment of the present invention.

FIG. 10A is a flow diagram illustrating the reception of user information for a first user object according to one embodiment of the present invention.

FIG. 11 is a diagram illustrating a revision history according to one embodiment of the present invention.

FIG. 12 is a flow diagram illustrating one embodiment of providing update information to access devices in a household.

FIG. 13 is a flow diagram illustrating one embodiment of receiving of update information for a user object.

FIG. 14 is a flow diagram illustrating one embodiment of determining an update for a particular access device.

FIG. 15 is a flow diagram illustrating one embodiment of adding a new access device to a household.

FIG. 16 is a flow diagram illustrating one embodiment of adding a user object to a household.

FIG. 17 is a flow diagram illustrating one embodiment of revising a user object.

FIG. 18 is a flow diagram illustrating one embodiment of using a single password to access multiple password protected services.

### DETAILED DESCRIPTION OF THE ILLUSTRATED EMBODIMENTS

Embodiments of a system and method for coordination of favorites among disparate devices in an interactive video casting system are described herein. In the following description, numerous specific details are provided, such as examples of devices that can be used for interaction with the interactive video casting system, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As an overview, an embodiment of the invention allows coordination of favorites among disparate devices (e.g., client terminals) in an interactive video casting system, such as in an interactive television system. The favorites can include, but not be limited to, favorite web site address, favorite synthetic channels, favorite broadcast channels, or other favorite sources of content. Users may set and access favorites on one device, and these settings can be sent to a server that correlates the settings with stored information, such as information in a database, other storage unit, file, and the like. The information stored by the server can include an identification of devices in a particular household, the users of the devices, and the current favorites settings. In an embodiment described in greater detail below, a user model technique can be used to treat the various devices as logical extensions of each other.

The correlation performed by the server can include determining which devices have to be updated with the new favorites settings. After such determination, the server can update the stored entries with the new favorites information and transmit the updated favorites information to the corresponding devices. In this manner, the user need not separately update each and every device whenever the favorites settings are updated. In one embodiment, the server can send updated favorites information to the devices when such information becomes available, independent of a request for such information from any one of the devices. In another embodiment, the devices can poll (e.g., request) the server for updated favorites information, and then in response to the request, receive updated favorites information that may be available.

It should be noted that the term “favorites” as used herein is not necessarily intended to imply frequently accessed content sources or addresses, sources or addresses that are preferred by the user over others, or other such things. A “favorite” according to one embodiment can include any content source or address that is saved/set, regardless of how many times the source or address is actually accessed or regardless of whether it is preferred or not by the user. A “favorite” is one type of setting that can be coordinated by embodiments of the invention.

In accordance with aspects of the present invention, a user model for interactive television systems is provided as a technique to coordinate favorites. In one aspect, the user model organizes access devices (e.g., STBs) into household objects (or simply “households”), with each access device in a household being logical extensions of each other. In particular, each access device has a corresponding access device “object” associated with a household.

In addition, each household can have multiple user objects, with each user object having its own independent configuration of attributes and data. This aspect of the present invention allows a user to create or reconfigure a user object by logging on to an authorized user object at any one of the access devices of the household. The other access devices (if any) in the household automatically receive the user object information of a new or reconfigured user object without any further action by the user. Thus, this aspect advantageously allows a single operation to configure and/or reconfigure all of the access devices in a household with the user object information of a new or revised user object. In a related aspect of the present invention, when a user adds a new access device to the household, the new access device automatically receives the user object information of user objects already existing in the household, without any further action by the user. In one embodiment, this automatic exchange of user object information is coordinated by a server that stores the configuration information of each household and its associated user objects. This server, for example, can be operated by a multiple service operator (MSO) or service provider. Alternatively or in addition, the server may be at a broadcast center for a satellite broadcast system.

In another aspect of the present invention, the information of a user object is updated using a revision information file. An access device sends updated user object information to a server when a user changes the user object information of a user object via that access device. In one embodiment, the server receives the updated user object information and stores the updated information in a file corresponding to the user object. In addition, the server creates an update entry for the received update information, which is stored in a list. The update entry includes a ticket number, and a bit vector with the bit corresponding to the updated information being set. The ticket number is incremented for each new update entry.

To update the user object information of user object in a particular access device, the server receives the ticket number of the access device's current configuration for that user object. The server then determines an update vector for that access device as a function of the access device's bit vector current ticket number and more recent bit vectors from other access devices. In one embodiment, the server then provides the update vector to that access device. That access device can then request the updated user object information corresponding to each set bit in the update vector. This operation is performed for all of the access devices in the household on an ongoing basis.

In yet another aspect of the invention, the user model supports associating multiple usernames and passwords to a user object. This aspect allows the user object to contain the user names and passwords to access various applications and services that may require separate passwords. For example, the interactive television system may provide, in addition to the basic interactive service, pay per view (PPV), parental control, video on demand (VOD) and electronic wallet applications or services. This aspect advantageously allows a user to access all of these applications and services using a single username and password. In a further refinement, any activity that initiates a billing event can cause a password challenge for verification before proceeding with the activity.

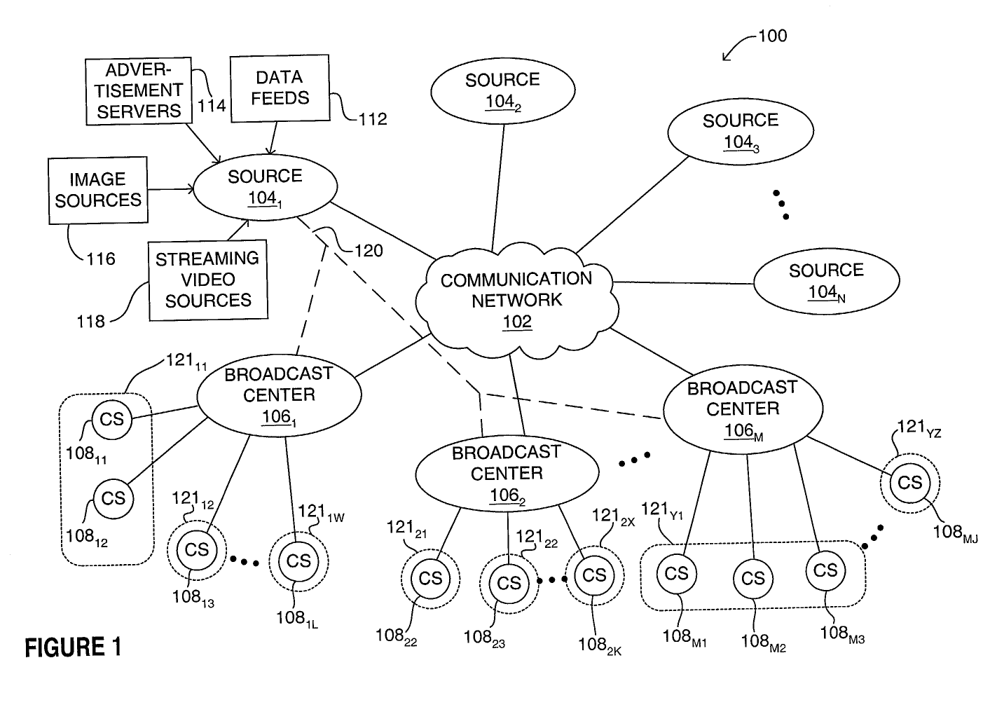

The present invention provides techniques for controlling access to an interactive television system. FIG. 1 depicts a simplified diagram of a system 100 for distributing Internet content and television content in which an embodiment of the present invention may be embodied. In accordance with an embodiment of the present invention, system 100 is integrated with a cable TV distribution system. Such cable television distribution systems may include cable headends (H/Es), which are well known in the art.

As shown in FIG. 1, system 100 includes a communication network 102, several content sources 104₁-104_{N}, several broadcast centers 106₁-106_{M} and several client systems (CSs) 108₁₁-108_{MJ}. In addition, system 100 also includes a server of the interactive television service provider, which can reside in one or more of broadcast centers 106₁-106_{M}. In accordance with the present invention, CSs 108₁₁-108_{MJ} (more particularly, access devices that are part of the CSs) are part of households 121₁₁-121_{YZ}. As will be described in further detail below, households allow for advantages in reconfiguring certain aspects of the CSs.

Communication network 102 provides a mechanism for distributing multimedia content from content sources 104₁-104_{N} to broadcast centers 106₁-106_{M}. Communication network 102 may itself be comprised of many networks, interconnected computer systems and communication links. While in one embodiment, communication network 102 is the Internet, in other embodiments, communication network 102 may be any suitable computer network. For purposes of describing the present invention, it will be assumed that communication network 102 is the Internet. Communications over Internet 102 are accomplished using standard protocols such as transmission control protocol/Internet protocol (TCP/IP) and other protocols. System 100 depicted in FIG. 1 is merely illustrative of an embodiment incorporating the present invention and does not limit the scope of the invention as recited in the claims. One of ordinary skill in the art would recognize other variations, modifications, and alternatives.

As shown in FIG. 1, content sources 104₁-104_{N} may be connected to Internet 102. Additionally, content sources 104₁-104_{N} may be connected to several data feeds, servers, and information sources that in turn provide content information to content sources 104₁-104_{N}. For example, content source 104, may be connected to receive content information from data feeds 112, advertisement servers 114, image sources 116, streaming multimedia sources 118, including streaming audio and streaming video sources, and other like sources of content information. For example, news or stock quote feeds 112 may be fed into content source 104₁, servers 114 may provide advertisements for insertion into multimedia content delivered by content source 104₁, and sources 116 and 118 may provide images, streaming video, and other content to content source 104₁. Various other feeds, servers and sources may also be connected to content source 104₁. Examples of content sources 104₁ include web site portals such as Go2Net.com, or news web sites such as CNN.com, and the like. Similarly, (although not shown in FIG. 1 to promote clarity) content sources 104₂-104_{N} may also receive content information from data feeds 112, advertisement servers 114, image sources 116, streaming multimedia sources 118.

Content sources 104₁-104_{N} may also be connected directly to broadcast centers 106₁-106_{M} via communication links or communication networks 120. Communication links 120 may include may be hardwire links, optical links, satellite or other wireless communication links, wave propagation links, or any other mechanisms for communication of multimedia content information.

Broadcast centers 106₁-106_{M} may be connected to Internet 102, and to content sources 104₁-104_{N} via communication links 120. Each broadcast center 106₁-106_{M} may also be connected to several CSs. For example, broadcast center 106₁ may be connected to CSs 108₁₁-108_{1L}, broadcast center 106₂ may be connected to CSs 108₂₁-108_{2K}, and so on, to broadcast center 106_{M}, which may connected to CSs 108_{M1}-108_{MJ}. Each broadcast center is configured to receive content information from its corresponding content source and/or from Internet 102, and to forward the content information to its corresponding CSs. The content information may include web content information, television content information and other multimedia content information. In a specific embodiment of the present invention, as shown in FIG. 1, broadcast centers 106₁-106_{M} comprise cable headends (H/Es).

A satellite TV delivery system may comprise a direct broadcast satellite (DBS) system. A DBS system may comprise a small 18-inch satellite dish (which is an antenna for receiving a satellite broadcast signal); a digital integrated receiver/decoder (IRD), which separates each channel, and decompresses and translates the digital signal so a television can show it; and a remote control. Programming for a DBS system may be distributed, for example, by multiple high-power satellites in geosynchronous orbit, each with multiple transponders. Compression (e.g., MPEG) is used to increase the amount of programming that can be transmitted in the available bandwidth.

A digital broadcast center may be used to gather programming content, ensure its digital quality, and transmit the signal up to the satellites. Programming may come to the broadcast center from content providers (TBS, HBO CNN, ESPN, etc.) via satellite, fiber optic cable and/or special digital tape. Satellite-delivered programming is typically immediately digitized, encrypted and uplinked to the orbiting satellites. The satellites retransmit the signal back down to every earth station—or, in other words, every compatible DBS system receiver dish at customers' homes and businesses. Some programs may be recorded on digital videotape in the broadcast center to be broadcast later. Before any recorded programs are viewed by customers, technicians may use post-production equipment to view and analyze each tape to ensure audio and video quality. Tapes may then be loaded into a robotic tape handling systems, and playback may be triggered by a computerized signal sent from a broadcast automation system. Back-up videotape playback equipment may ensure uninterrupted transmission at all times.

As previously mentioned, in accordance with the present invention, the CSs are organized into households. For example, in this embodiment, a household 121₁₁ includes CSs 108₁₁ and 108₁₂. A household can include a single CS as shown for example, by a household 121_{1W} that includes only CS 108_{1L}. Further, as shown in FIG. 1, a broadcast center can support one or more households.

Each CS can receive multimedia content, including web content and television content, from its corresponding broadcast center. Each CS can then output received multimedia content to a user of the household containing the CS. For example, in the embodiment of FIG. 1, CS 108₁₁ receives multimedia content from broadcast center 106₁ and outputs the multimedia content to a user of household 121₁₁. In one embodiment, each CS includes an access device that allows a user to receive authorized multimedia content and to communicate with the server of the interactive television service provider.

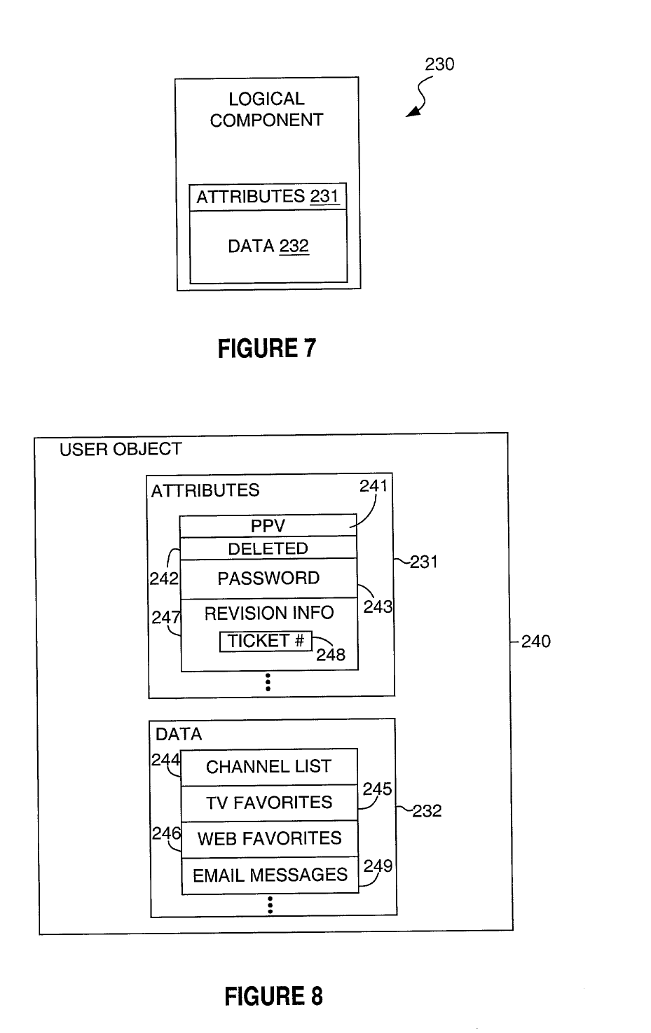

In addition, according to an embodiment of the present invention, each household can have multiple user objects, with each user object having its own independent configuration of attributes and data. For example, a user object may have an administrator attribute, when enabled, allows the user object to change the configuration of other user objects. Attributes and data are described below in more detail in conjunction with FIGS. 7 and 8.

In general, a user accesses the interactive television system by logging on to a user object. A user can create or reconfigure a user object via any one of the CSs in the household by logging on to an authorized user object (e.g., a user object that has its administrator attribute enabled). The server of the interactive television service provider receives information related to the new or reconfigured user object and provides update information to the other CSs (if any) in the household. In this way, other CSs in the household are automatically reconfigured with the new user object information without any further action by the user. Thus, a user can configure all of the CSs in a household with a new or revised user object in a single operation. In this manner, whenever a favorites setting at any of the access devices is revised, the revised favorites setting can be provided to all of the access devices in the household. As will be described below, one embodiment of a CS includes an “access device” that can store information (including information related to user objects associated with the household). Thus, households are also described herein as having “access devices” rather than CSs (which can include components in addition to an access device).

In another aspect of the present invention, when a user has a new CS added to the household, information associated with the new CS is received by the server of the interactive television service provider. This server can then provide the most recent user object information to the new CS, including favorites settings. In one embodiment, a user is logged onto a user object with its administrator attribute enabled to add a new CS to the household. In this way, the new CS automatically receives the user objects associated with the household without any further action by the user.

In yet another aspect of the invention, user objects can also contain the separate usernames and passwords that may be needed to access various applications and services that the interactive television system provides. For example, the interactive television system may provide, in addition to the basic interactive service, pay per view (PPV), parental control, video on demand (VOD) and electronic wallet applications or services. These applications and services, in addition to having different usernames and passwords, may also be linked to specific access devices. This aspect advantageously allows a user to access all of these applications and services using a single username and password. In contrast, some conventional systems require that a user remember several different usernames and passwords for the various applications and services and may even require different usernames and passwords to access the same service from different access devices. In a further refinement, any activity that initiates a billing event can cause a password challenge for verification before proceeding with the activity.

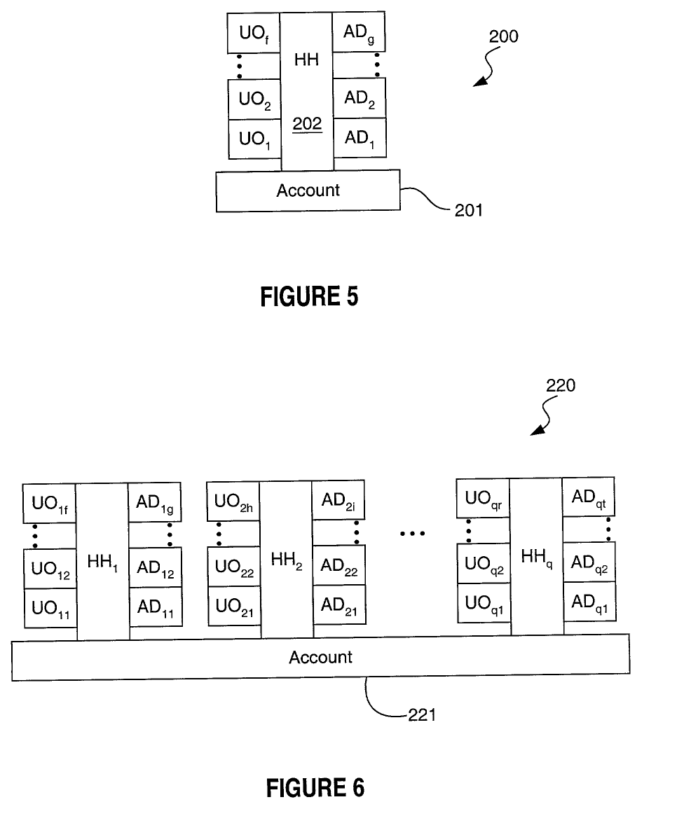

Embodiments of processes using the user model are described below in conjunction with FIGS. 5-17. However, embodiments of hardware used to implementing the processes are described next.

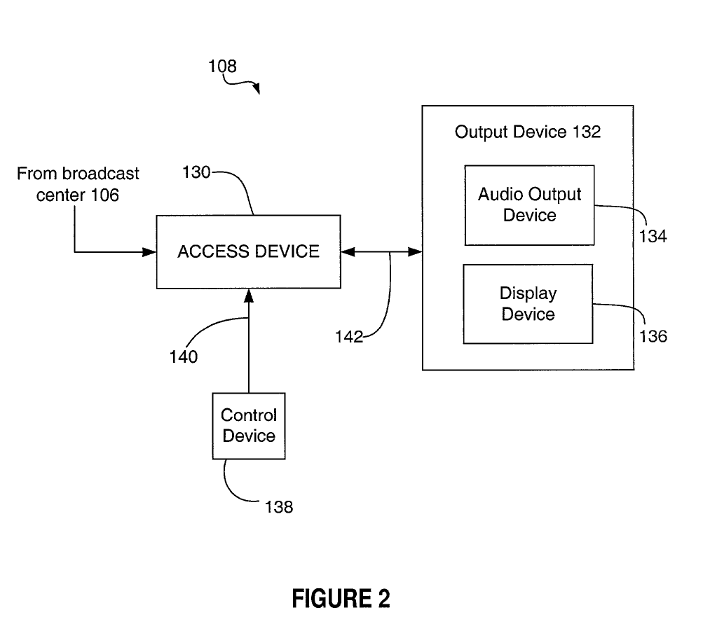

FIG. 2 depicts a simplified block diagram of a CS 108 according to an embodiment of the present invention. CS 108 can be used to implement any or all of CSs 108₁₁-108_{MJ} (see, e.g., FIG. 1). This embodiment of CS 108 includes an access device 130 connected to an output device 132 via communication link 142, and a control device 138 connected to access device 130 via a communication link 140. Access device 130 can comprise a STB, a television with built-in interactive capability, a personal computer (PC), a Web Pad (e.g., a PC in tablet form that uses a touch screen rather than a keyboard), a personal digital assistant (PDA), a cellular telephone, a pager, a hybrid device combining some of the features and functionalities of the preceding devices, or other such devices, suitable for interacting with the Internet 102, cable system operator and/or other media service operators.

Output device 132 is configured to output multimedia content information to the user of CS 108. In some embodiments, output device 132 may be implemented as a television or other display device, or can be built in as part of access device 130 (e.g., PC, PDA, or other like device). In an embodiment of the present invention, access device 130 and output device 132 is part of a broadband Internet-enabled television system.

Output device 132 may include an audio output device 134 for outputting audio information to the user, and a display device 136 for outputting video, image, and text information to a user. Display device 136 may be a cathode ray tube (CRT), a flat-panel device such as a liquid crystal display (LCD), a projection device, or any other device suitable for outputting visual information, including streaming video, images, and text, to the user. Audio output device 134 may be a speaker, or any other device suitable for outputting audio information embedded in the web content and television content received from a broadcast center (see, e.g., FIG. 1) to the user. Although, FIG. 2 depicts an output device in which display device 136 and audio output device 134 are integrated into one output device 132, in alternate embodiments of the present invention the display device and the audio output device may be embodied in separate devices.

Control device 138 may be used by the user to control the functionality of CS 108. Control device 138 communicates with access device 130 via communication link 140 that is generally an infrared (IR) communication link. However, in alternate embodiments of the present invention, communication link 140 may also be a hardwire link, an optical link, or any other means for communicating information from control device 138 to access device 130. Control device 138 may be embodied as a television remote control device, a keyboard, a mouse, or any other device which allows a user to input information to CS 108.

According to an embodiment of the present invention, access device 130 is implemented as a STB that includes hardware and software to receive multimedia content information, including web content and television content, from broadcast centers 106₁-106_{M} (see, e.g., FIG. 1). Access device 130 also contains hardware and software to output the multimedia content to the user via output device 132. Access device 130 also performs functions allowing the user to control the manner in which the multimedia content is downloaded to CS 108 and presented to the user. Access device 130 includes components and modules that regulate a user's access to web and television content output by access device 130. Access device 130 is connected to output device 132 via communication link 142. Communication link 142 may include a video channel for communicating video information from access device 130 to output device 132 and an audio channel for communicating audio information from access device 130 to output device 132.

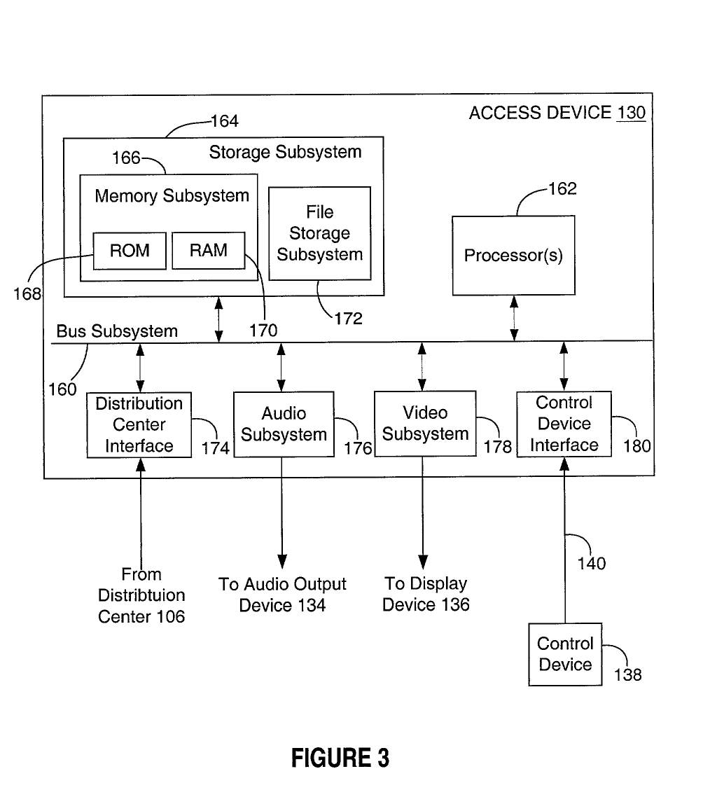

FIG. 3 is a simplified block diagram of an example access device 130 according to an embodiment of the present invention. Access device 130 typically includes at least one processor 162 that communicates with a number of peripheral devices via a bus subsystem 160. These peripheral devices may include a storage subsystem 164, comprising a memory subsystem 166 and a file storage subsystem 172, a video subsystem 178, an audio subsystem 176, a broadcast center interface subsystem 174, and a control device interface subsystem 180.

Distribution interface subsystem 174 provides an interface for receiving multimedia content information from broadcast center 106. The multimedia content is then processed and forwarded to display device 136 and/or to audio output device 134 for output to the user. Control device interface subsystem 180 detects signals received from control device 138 and provides instructions/information encapsulated in the signals to processor 162 for further processing.

Audio subsystem 176 is responsible for processing audio content received from broadcast center 106, and transmitting the processed audio signals to audio output device 134 for output to the user. Likewise, video subsystem 178 is responsible for processing video content received from broadcast center 106, and transmitting the processed video signals to display device 136 for output to the user.

Storage subsystem 164 can store the programming modules and data constructs that provide the functionality of the various systems embodying the present invention. For example, databases and modules implementing the functionality to regulate access to web and television content according to the teachings of the present invention may be stored in storage subsystem 164. Processor 162 generally executes these software modules. Storage subsystem 164 may comprise memory subsystem 166 and file storage subsystem 172. A browser or other application to access and view web content may be stored in any of the suitable storage components shown in FIG. 3.

Memory subsystem 166 typically includes a number of memories including a main random access memory (RAM) 170 for storage of instructions and data during program execution and a read only memory (ROM) 168 in which fixed instructions are stored. File storage subsystem 172 provides persistent (non-volatile) storage for program and data files, and may include a hard disk drive, a floppy disk drive along with associated removable media, a compact digital read only memory (CD-ROM) drive, an optical drive, or removable media cartridges. The databases and modules implementing the functionality of the present invention may also be stored by file storage subsystem 172.

Bus subsystem 160 provides a mechanism for letting the various components and subsystems of access device 130 communicate with each other as intended. Although bus subsystem 160 is shown schematically as a single bus, alternate embodiments of the bus subsystem may utilize multiple buses. Further, in alternate embodiments of the present invention, the various components of access device 130 may be directly connected to processor 162.

Due to the evolving nature of processing units 130, the description of access device 130 depicted in FIG. 3 is intended only as a specific example for purposes of illustrating one embodiment of the present invention. Many other configurations of access device 130 are possible having more or less components than the access device 130 depicted in FIG. 3. In light of this disclosure, those skilled in the art will be able to implement different embodiments of access device 130 without undue experimentation.

As previously mentioned, according to an embodiment of the present invention, access to multimedia content is regulated by defining or configuring one or more user objects of CSs 108₁₁-108_{MJ} (see, e.g., FIG. 1). Each user object specifies a level of access to the web or television content information. Each user object is generally characterized by attributes such as, for example, a user identification code that is used to identify the user object, and a set of privileges associated with the user object. Using CS 108 (see, e.g., FIG. 2) as an example, a user of CS 108 may log onto a particular user object, which may require the user to enter a password. The privileges associated with that particular user object define: (1) the web or television content that the user can access and (2) the manner in which the user interacts with system 100 (see, e.g., FIG. 1). In a specific embodiment of the present invention, information related to the various user objects is stored in access device 130 of CS 108 and in the server of the interactive television service provider.

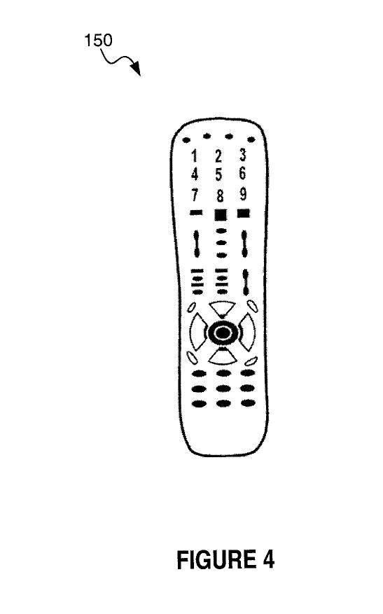

FIG. 4 depicts an example control device 150 according to an embodiment of the present invention. Control device 150 may be used to control the functionality of CS 108 (see, e.g., FIG. 2). As shown, control device 150 has the general appearance of a common, hand-held remote comprising several buttons to control the functions of CS 108 (see, e.g., FIG. 2).

FIG. 5 illustrates logical objects of a single household system 200, according to one embodiment of the present invention. This embodiment of the system 200 includes four types of logical objects (e.g., an account 201, a household 202, user objects UO₁-UO_{f}, and access device objects AD₁-AD_{g}). System 200 illustrates the relationship between the logical objects of a single household model. User objects UO₁-UO_{f} and access device objects AD₁-AD_{g} are associated with household 202, which in turn is associated with account 201. Account 201 represents an account maintained by the interactive television service provider for record keeping and billing purposes (e.g., a MSO account). User objects UO₁-UO_{f} and access device objects AD₁-AD_{g} are, in effect, contained in household 202 so that, for example, a change in one of user objects UO₁-UO_{f} (such as a change in a favorites setting) will apply to all of the access device objects AD₁-AD_{g}. In addition, in one embodiment, a single user object may be simultaneously logged on in several access devices.

FIG. 6 illustrates logical objects of a multi-household user system 220, according to one embodiment of the present invention. System 220 is similar to system 200 (see, e.g., FIG. 5) except that instead of a single household 202 (see, e.g., FIG. 5), system 220 includes an account 221 associated with multiple households. In the example system shown in FIG. 6, system 220 includes households HH₁-HH_{q}, with each of these households having user objects and access device objects. In this embodiment, household HH₁ is associated with user objects UO₁₁-UO_{1f} and access device objects AD₁₁-AD_{1g}; household HH₂ is associated with user objects U0₂₁-UO₂ₕ and access device objects AD₂₁-AD₁ᵢ; and so on to household HH_{q}, which is associated with user objects UO_{q1}-UO_{qr} and access device objects AD_{q1}-AD_{qt}.

FIG. 7 illustrates elements associated with a general logical object 230, according to one embodiment of the present invention. As previously described, accounts, households, user objects, and access devices are all represented as logical objects in the user model. Also described above, in accordance with the present invention, a logical object is associated with attributes and data. In FIG. 7, these are indicated as attributes 231 and data 232. In this embodiment, attributes 231 are related to predefined characteristics of the logical object. For example, a user object's attributes may include an administrator attribute (which if enabled allows the user object to have access to defined administrative privileges), an email attribute (which if enabled allows the user object to send and receive email), among other characteristics. In this embodiment, data is information that is stored on behalf of the logical object. For example, a user object's data may include a user name, a channel list (a list of channels that the user object has permission to view), web site favorites, among other types of information. Tables 1-4 in Appendix A summarize attributes and data that can be used for user object, household, access device and account logical objects, respectively.

FIG. 8 illustrates attributes and data associated with an example user object 240, according to one embodiment of the present invention. In this embodiment, in addition to the administrator and email attributes previously described, attributes 231 associated with user object 240 can include a “pay per view” (PPV) attribute, which allows the user object to view PPV programs when enabled. In addition, attributes 231 can include a “deleted” attribute (which when set indicates that the user object has been deleted from the household), and a “password” attribute (which when set allows the user object to log on into the user object without having to enter a password). In other embodiments, user object 240 may have other attributes such as, for example, those listed in Table 1 of Appendix A. Information related to attributes 231 and data 232 can be stored in the server of the interactive television system and in the access device(s) of a household.

In this embodiment, data 232 associated with user object 240 can include a channel list 244, a list of favorite television channels 245, a list of favorite web sites 246, and revision information 247. Revision information 247, in this embodiment, includes a ticket number 248. Ticket number 248 is used in updating the user object's information in all of the access devices in the same household as user object 240. Ticket number 248 and the updating process are described in more detail below. In an alternative embodiment, revision information 247 may be part of attributes 231 because revision information 247 generally does not include information directly provided by a user (rather in one embodiment the server generates the revision information from data provided by the user). Data 232 may also include email messages 249 when the email feature is used. In other embodiments, data 232 can include other types of data such as, for example, those listed in Table 1 of Appendix A. As previously mentioned, some or all of this information can be stored in the server and in the access device(s) of a household. For example, an access device can store information such as channel list 244, television favorites 245, web favorites 246 and revision information 247.

In accordance with an embodiment of the invention, the list of favorite web sites 246 can comprise the favorites settings, such as URL addresses or other network addresses of web sites. The favorites settings can also include the list of favorite television channels 245. The list of favorite television channels 245 can comprise broadcast television channels and synthetic television channels. Synthetic television channels can be embodied as specialized channels or web sites operated by the cable service provider, MSO, or other party that are presented as part of the channel lineup to the viewers. These synthetic channels can be designed such that they have the look and feel of a conventional television broadcast channels and can be tuned to as if tuning to a conventional television broadcast channel—with the exception that the synthetic channels provide enhanced interactive features.

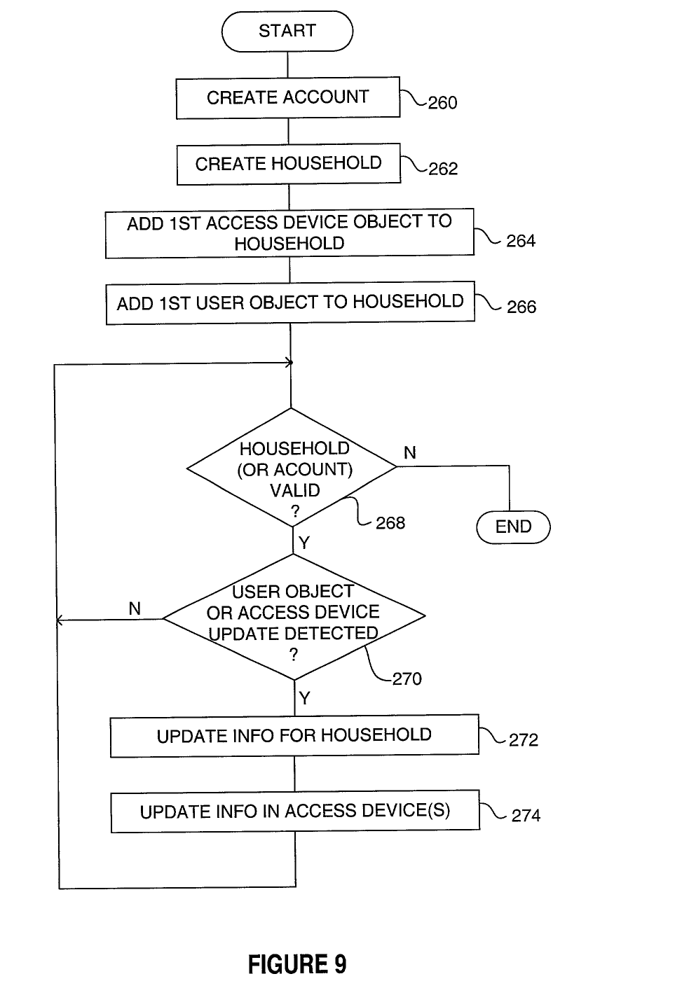

FIG. 9 illustrates an operational flow in using a user model according to one embodiment of the present invention. In a block 260, the operational flow begins with creating an account. For example, in one embodiment, a customer can open the account with an interactive television service provider (e.g., a MSO). The interactive television service provider operates a server used to control access to services and multimedia content provided by the interactive television service provider. As previously described, this server can reside in one or more of broadcast centers 106₁-106_{M} (see, e.g., FIG. 1). The interactive television service provider instantiates the new account so that the server can access information associated with the account.

In a block 262, a household for the account is created. Continuing the example described above in conjunction with block 260, the interactive television service provider instantiates a household for the customer, which is associated with the account created in block 260. In other embodiments, the interactive television service provider can create more than one household for the account. The server can access information associated with the household.

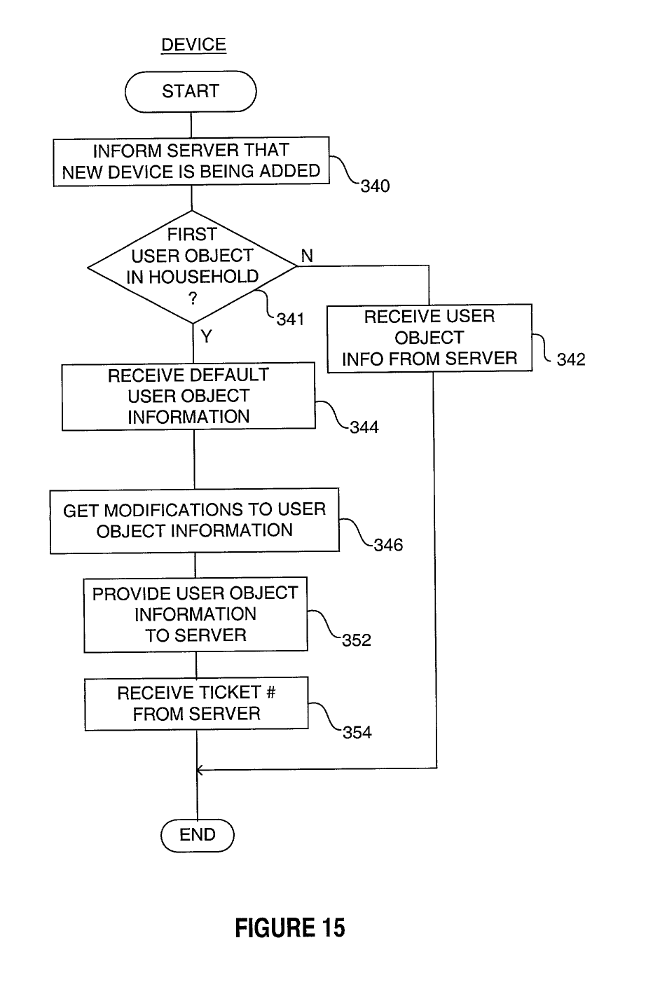

In a block 264, an access device object is created and associated with the household created in block 262. In one embodiment, when a user connects the physical access device to a broadcast center (e.g., a H/E), the server detects the physical access device and instantiates a corresponding access device object. The server associates the access device object to the household. One embodiment of a process of entering information for a new access device object is described below in conjunction with FIG. 15.

Although blocks 260, 262 and 264 are described sequentially, in light of the present disclosure, those skilled in the art can implement other embodiments in which these blocks are performed in different orders. For example, in one embodiment, the household may be created before the account is created. In another embodiment, installing the first access device can cause blocks 260 and 262 to be performed.

In a block 266, a user object is created and associated with the household created in block 262. As previously mentioned, a user can access the interactive television system via an installed access device to create a user object. In addition, in one embodiment of block 266, a first user object is automatically created or instantiated when the first access device is installed. This first user object is automatically given permission to access all of the features and privileges supported by the interactive television system. Thus, in one embodiment, the first user object is instantiated as an administrator, which allows this user object to create and modify other user objects. An authorized user can use this first user object to add other user objects and access device objects as described below.

In a block 268, the household and/or account is validated. This operation can be used to verify that the interactive television service provider has not terminated service for that particular household or account. In one embodiment, the server verifies that the household or account is authorized to access the interactive television system. If the account or household is not valid, the operation terminates; otherwise, the operational flow proceeds to a block 270.

In block 270, the interactive television system is monitored for updates related to user objects (such as revisions to the favorites settings) and access device objects. For example, in one embodiment, the server of the interactive television service provider can be configured to detect, inter alia, installation of a new access device, addition of a new user object to the household, and revision of information for an existing user object or access device object. In one embodiment, a user can upload this update information via one of the access devices that are installed on the interactive television system. If the server does not detect any such update, the operational flow loops back to block 268. Conversely, if the server does detect an update, the operational flow proceeds to a block 272.

In block 272, the update information is received and stored for the household by the interactive television system. In one embodiment, the server stores this received update information. In this embodiment, the server maintains a record of information for the account logical object, and the associated household, user and access device logical objects.

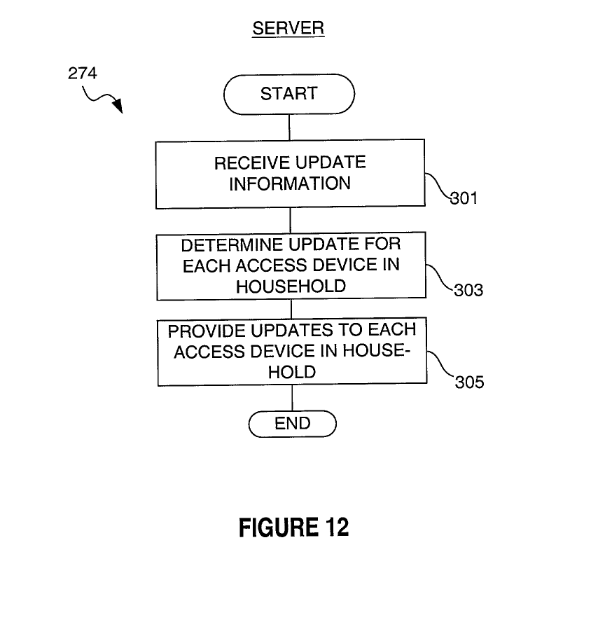

In a block 274, the update information is then distributed to the access devices associated with the household. In one embodiment, the server sends the update information received via an access device to all of the other access devices of the household. One embodiment of this operation is described in more detail below, in conjunction with FIG. 12. The operational flow then loops back to block 268.

Although blocks 268, 270, 272, and 274 are described sequentially, in light of the present disclosure, those skilled in the art can implement other embodiments in which the blocks are performed in a different order, or with some blocks performed concurrently.

A situation may arise when a user attempts to update information for a logical object while another user is already updating that particular logical object. In one embodiment, the most recent update information is used while the earlier update information is disregarded (e.g., the race condition is resolved using last-in semantics). In another embodiment, the first user to begin the updating operation locks out the second user until the first user's update is completed.

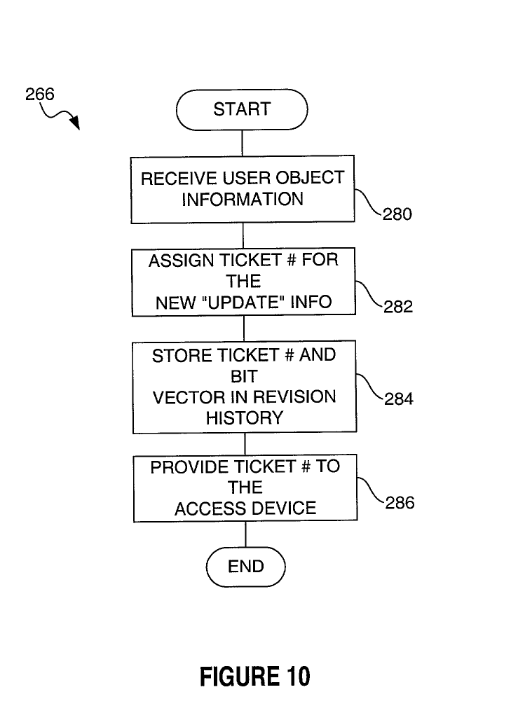

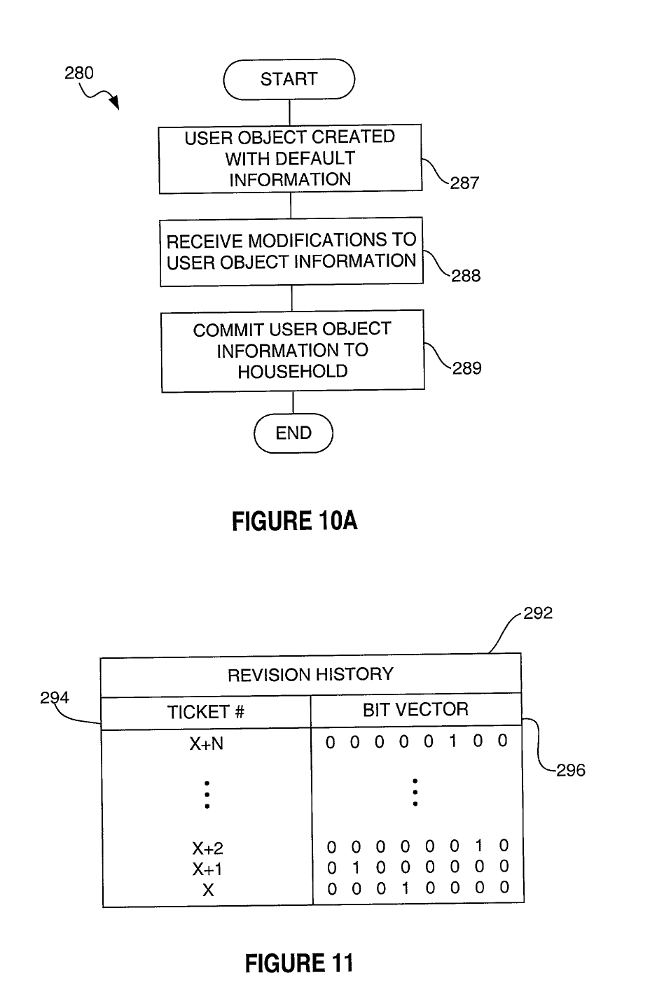

FIG. 10 illustrates the operational flow of block 266 (see, e.g., FIG. 9), according to one embodiment of the present invention. In particular, FIG. 10 illustrates the addition of a new user object to a household, according to one embodiment of the present invention.

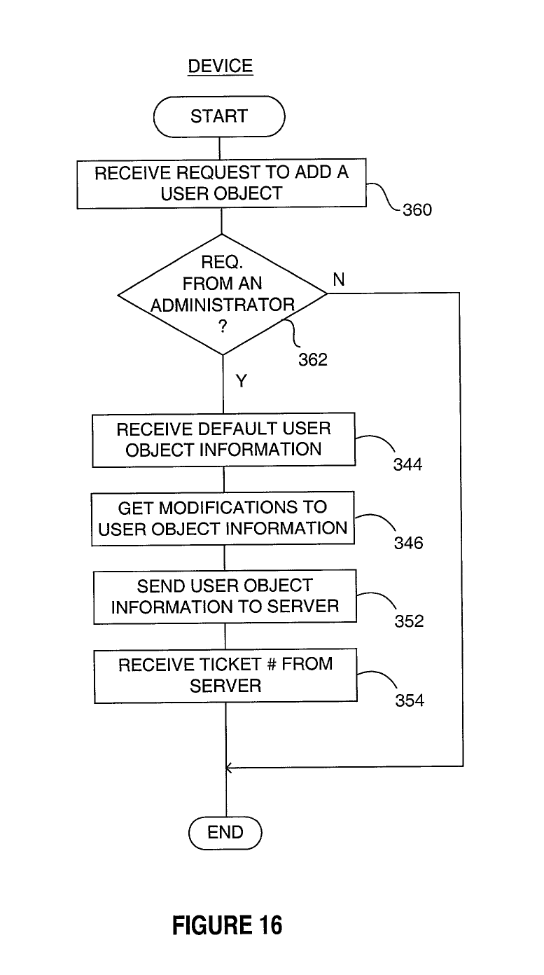

In a block 280, information for a new user object is received. In one embodiment, the server of the interactive television system receives this information from either a user via an access device, or from a customer service representative (CSR) of the interactive television service provider. For example, a user can provide the new user object information to the server via the access device. This user object information can include an identifier (e.g., identifying the particular configuration parameter) and a value for a particular configuration parameter of the new user object. One embodiment of block 280 is described below in conjunction with FIG. 10A. In addition, one embodiment of a process by which a user enters a new user object is described below in conjunction with FIG. 16.

In a block 282, the received user object information of the new user object is assigned a ticket number. In one embodiment, the server increments the most recent ticket number the server has used and assigns this incremented ticket number to the received user object information. In this way, the server provides an identifier to each received set of user object information.

In a block 284, the ticket number and a bit vector for the received user object information is stored. In one embodiment, the server stores the ticket number and the bit vector in a revision history. The revision history can be of fixed size, with a new entry (e.g., ticket number and corresponding bit vector) replacing the oldest remaining entry if the revision history is full.

In this example embodiment, each bit of the bit vector corresponds to a configuration parameter or setting (hereinafter configuration parameter) of a user object. A bit in the bit vector is set when the corresponding configuration parameter is “updated” (which includes adding a value for a newly created user object).

In a block 286, the ticket number is provided to the particular access device that was used to provide the user object information of the new user. In one embodiment, the server provides the ticket number to the access device. The access device can store the ticket number as a way of keeping track of its configuration. In one embodiment, the access device stores the ticket number in revision information file 247 (see, e.g., FIG. 8). In other embodiments, block 286 may be performed before or concurrently with block 284.

FIG. 10A illustrates block 280 in which user object information is received, according to one embodiment of the present invention. In one embodiment, a block 287 is performed in which the user object is created. In an embodiment, the server of the interactive television system creates the user object with default information. For the first user object being created, the default includes setting the administrator attribute. For subsequent user objects, the administrator attribute would not be set. In one embodiment, the server causes the access device to display the default information, which the user or CSR can modify. For example, this information may be presented in a menu. The user or CSR could then select a desired setting and modify it. In another embodiment, the access device may be configured to display the menu when it is first connected to interactive television system 100. In another embodiment, for example, the access device may be configured to prompt the user to enter information for each setting instead of a using a menu.

In a block 288, modifications to the default settings are received. In one embodiment, the server receives the modifications from the access device. Alternatively, the modifications can be provided through another mechanism (e.g., from a CSR through a computer terminal). For example, after the user has completed all of the modifications, the access device may prompt the user or CSR for a confirmation and then send the modifications to the server.

In one embodiment, the server receives a series of user object information messages from the access device. Each message has a value for one configuration parameter and a bit vector with the bit corresponding to the configuration parameter being set. The server of the interactive television system stores this user object information.

In an alternative embodiment, the access device would send a message with a bit in the associated bit vector being set to indicate that the user object information corresponds to a new user object. The message would also include the values for all of the configuration parameters in a predefined order.

In a block 289, the user object information is committed to the corresponding household. In one embodiment, after all of the configuration information is received, the server stores the received user object information and associates it with the household of block 262 (see, e.g., FIG. 9).

FIG. 11 illustrates a revision history 292, according to one embodiment of the present invention. In this embodiment, revision history 292 can store N (N being an integer greater than or equal to zero) entries related to a particular household (e.g., each household will have its own revision history). In this example embodiment, revision history 292 includes a ticket number field 294 and a bit vector field 296. Revision history 292 can include other fields (not shown) in other embodiments. In one embodiment, each entry's bit vector can have only one bit set. In the example embodiment shown in FIG. 11, revision history 292 is completely filled with N entries. These entries have ticket numbers X through X+N (X being an integer greater than or equal to zero) and corresponding 8-bit bit vectors. For example, the earliest entry in revision history 292 has a ticket number X and a bit vector of “00010000”, and latest entry has a ticket number X+N and a bit vector of “00000100”. In other embodiments, a bit vector can have more than one bit set. As will be described in more detail below, revision history 292 can be used to determine the updates needed for the access devices in its associated household.

FIG. 12 illustrates one embodiment of block 274 (see, e.g., FIG. 9), according to an embodiment of the present invention. As previously described, block 274 updates information in access devices in a household. For instance, the embodiment shown in FIG. 12 can be used to provide revised favorites settings to other access devices in a household, after one of the access devices is used to revise the favorites settings and to send the revised favorites settings to the server.

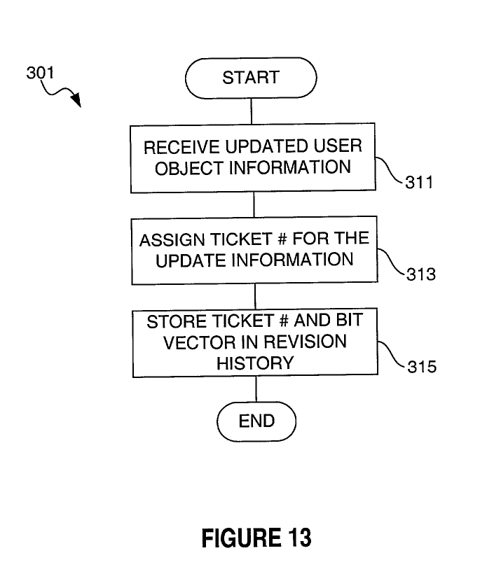

In a block 301, updated information is received. In one embodiment, the server receives the updated information from an access device of a household. In an alternative or additional embodiment, the updated information is received from another source (e.g., from a CSR using a computer). One embodiment of block 312 is described in more detail below in conjunction with FIG. 13.

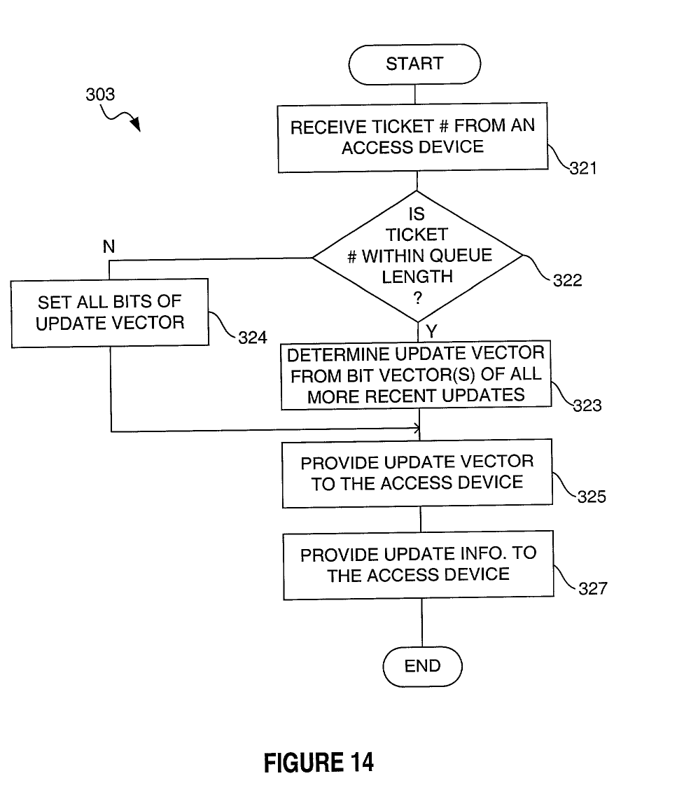

In a block 303, updates for each access device in the household are determined. In one embodiment, the server determines these updates using a polling scheme in conjunction with revision history 292 (see, e.g., FIG. 11) and the access device's most recent ticket number. One particular implementation of the polling scheme embodiment is described below in conjunction with FIG. 14. In other embodiments, when a user instantiates a user object via an access device, the access device may send a message with its most recent ticket number to the server, which then determines the update to send back to that access device using revision history 292. The server may be configured to determine only the updated user object information for the instantiated user object, rather than all the updates for needed by that particular access device. In another embodiment, each access device may be configured to periodically send messages with its most recent ticket number to check for updates.

In a block 305, updated user object information is provided to the access devices in the household. In one embodiment, the server provides the updated user object information determined in block 303 above. For example, when an access device sends its most recent ticket number to the server, the server determines the update as in block 303 and then sends updated user object information to that access device in block 305. In one embodiment, the server would send to the access device an update vector. The update vector would have one or more set bits, each set bit indicating a particular configuration parameter to be updated in that access device. The access device would then request updated information from the server as indicated by the bits that are set in the update vector. In one embodiment, the access device would request the indicated updated user object information one configuration parameter at a time. This process would then be repeated for all of the other access devices in the household that are coupled to the server. In this manner, URL addresses corresponding to updated web site favorites, for instance, can be sent from the server to the access device(s).

FIG. 13 illustrates an implementation of block 301 (see, e.g., FIG. 12), according to one embodiment of the present invention. This process is similar to the process of adding a new user object as described above in conjunction with FIG. 10, with a few minor exceptions as described below.

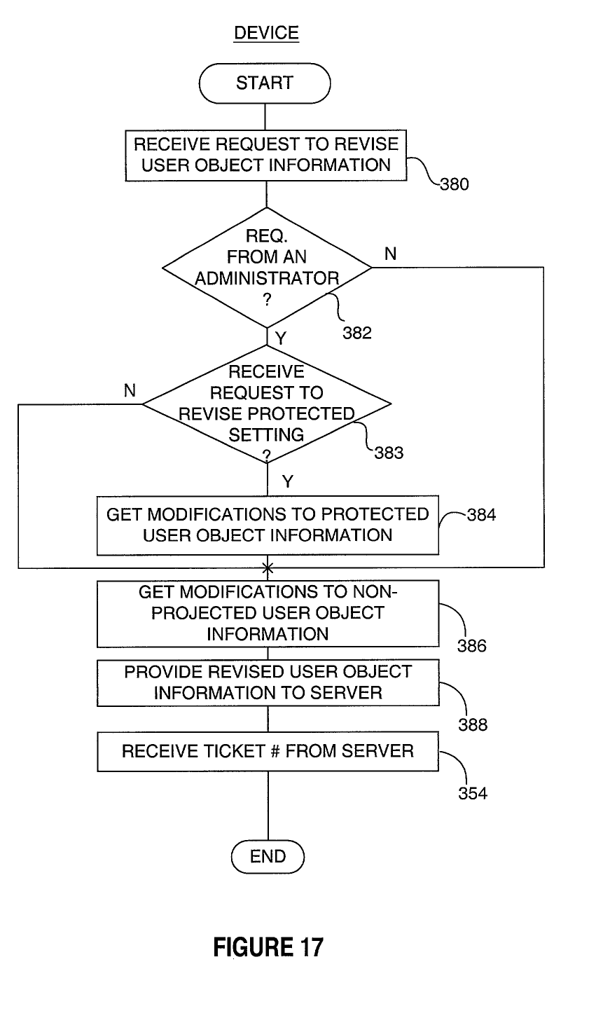

In a block 311, updated user object information for an existing user object is received. In one embodiment, the server of the interactive television system receives this updated user object information from a user via an access device or from a CSR via an access device or computer. One embodiment of a process of entering this updated user object information is described below in conjunction with FIG. 17. In accordance with one embodiment of the present invention, the user object information can include a value for the particular configuration parameter being updated and a bit vector with the bit corresponding to that configuration parameter being set. The server of the interactive television system can then store the received updated user object information.

In a block 313, the received updated user object information is assigned a ticket number. In one embodiment, the server increments the most recent ticket number in revision history 292 (see, e.g., FIG. 11) and assigns this incremented ticket number to the received user object information.

In a block 315, the ticket number and the bit vector for the received user object information is stored. In this embodiment, the server stores the ticket number and the bit vector in the revision history (see, e.g., FIG. 11), replacing the oldest remaining entry if revision history 292 is full.

FIG. 14 illustrates an implementation of block 303 (see, e.g., FIG. 12), according to one embodiment of the present invention. As previously described, block 303 determines the updated information to provide to a particular access device.

In a block 321, a ticket number corresponding to the current configuration of an access device is received. In one embodiment, the server of the interactive television system receives the ticket number from its corresponding access device. For example, an access device could provide the ticket number in response to a query from the server or, alternatively, in response to an instantiation of a user object in that access device (described above in conjunction with FIG. 12). The server can keep a record of the ticket number and the access device that provided the ticket number.

In a block 323, an update vector is determined. In one embodiment, the server determines the update vector using the received ticket number and revision history 292 (see, e.g., FIG. 11). In this embodiment, for example, the server determines the logical-OR of the bit vectors of all of the entries in revision history 292 associated with ticket numbers that are more recent than the received ticket number. These more recent ticket numbers are associated with updates that occurred after the current configuration of the access device. The resulting update vector will typically have some bits that are set and some that are not, with the set bits indicating configuration parameters that need to be updated. If all of the ticket numbers stored in revision history 292 are more recent than the received ticket number, the server can set all of the bits in the update vector (e.g., indicating that all of the user object information in that access device needs to be updated).

In a block 325, the update vector is provided to the access device. In one embodiment, the server provides the update vector to the access device. The server can provide this update vector to the access device automatically after determining the update vector for that access device. In an alternative embodiment, the server can wait for a request from the access device before providing the update vector to the access device.

In a block 327, the server then provides to the access device the user object information corresponding to the set bit or bits of the update vector. For example, as previously described, each time a configuration parameter is updated, the server stores this updated information. Thus, the server should have the most up-to-date configuration of each logical component in the household. In one embodiment, the server can provide the value for each of these configuration parameter(s) in response to a request by the access device. In this embodiment, the access device, having received the update vector, knows which configuration parameters need to be updated. The access device can then request the most recent value of each configuration parameter from the server when convenient for the access device. The access device can request the updates one configuration parameter at a time or in one request. In an alternative embodiment, the server, having determined the update vector, can push the updated values onto the access device.

In addition, the ticket number associated with each update is provided to the access device. In one embodiment, the server sends this ticket number to the access device along with the corresponding updated user object information. For example, in an embodiment in which the server pushes the updated values to the access device, the server can push them in reverse order (e.g., the most recent update being last). The server can provide the updated value, a bit vector with a bit set to indicate the configuration parameter of the updated value, and the ticket number of the update. The access device can overwrite the ticket number in its revision information file 247 (see, e.g., FIG. 8) with each update received from the server. Alternatively, in an embodiment in which the server provides all of the updates in one message, the server can provide all of the updated values and the ticket number corresponding to the most recent update in the group of updated values.

FIG. 15 illustrates one embodiment of adding a new access device to a household, according to the present invention. The operational flow starts when a user couples a new access device to the interactive television system (e.g., by connecting the access device to a broadcast center). In this context, a new access device is an access device that does not have an access device object associated with a household. In this example embodiment, the access device is configured to perform the blocks of the operational flow.

In a block 340, the server of the interactive television system is informed that a new access device is being connected to the interactive television system. In one embodiment, the access device is configured to send a message to the server indicating that it has not been associated with a household. In a further refinement, the access device can prompt the user installing the access device to enter the household (e.g., via a household login procedure) and then provide this household information in the message that the access device sends to the server.

In a block 341, the access device determines whether there are any user objects associated with the household. For example, if the access device is the first access device added to the household, it is possible that the household does not yet have a user object. In one embodiment, in response to the access device's message in block 340, the access device receives a message from the server that indicates whether the access device is the first access device of the household. If the access device is not the first access device of the household, a block 342 is performed in which the access device receives user object information from the server. For example, the server may send (e.g., push) the most recent user object information for all of the user objects associated with the household (including the most recent ticket number) to the access device. The access device's configuration information can, for example, include a media access control (MAC) address, personal identification numbers (PINs) for various services provided by the interactive television system, and a list of privileges for default operation (e.g., without logging onto a user object). In addition, the access device can provide the access device's configuration information to the server in order to create a new access device object. Alternatively, the access device may request (e.g., pull) the most recent user object information from the server of the interactive television system.

Conversely, if the access device is the first access device of the household, the operational flow proceeds to a block 344, which begins the operation of creating a first user object. In an alternative embodiment, the first user object may have been created by the interactive service provider beforehand when the user subscribed to the service, allowing the user to skip block 344.

In block 344, the access device begins the process to create the first user object. In one embodiment, this first user object is provisioned with default information. The first user object has its administrator attribute automatically enabled. This configuration setting is performed automatically because the first user object to be added to the household generally indicates that a new account is being created. As previously described, when an account is created, a household is automatically created. In addition, when the first access device for the household is activated, the first user object can also be created in block 344. The first user object is created with administrator privileges enabled so that an authorized user can log onto the first user object to create and update other user and access device objects.

In a block 346, the access device receives modifications to the default user object information. For example, the access device can display the default information in a menu. The user or CSR can then select information items from the menu to modify.

In an alternative embodiment, the access device prompts the user to enter the new user object information via control device 138 (see, e.g., FIG. 2). The access device receives the new or modified user object information and can store it as part of its attributes 231 and data 232 (see, e.g., FIG. 7).

In a block 352, the access device provides to the server the user object information the access device received for the first user object in block 346. In one embodiment, the access device provides this information in a series of messages to the server. Alternatively, the access device can provide each piece of user object information to the server before prompting the user to enter the next piece of information.

In a block 354, the access device receives a ticket number from the server. As previously described, the ticket number indicates the current configuration of the access device. In one embodiment, the server provides a ticket number in response to each piece of user object information received from the access device. This embodiment is useful in embodiments of block 352 in which the access device provides each piece of user object information to the server before prompting the user for the next piece of information.

FIG. 16 illustrates one embodiment of adding a user object to a household, according to the present invention. The operational flow of one embodiment starts with a user being logged onto an existing user object. In this example embodiment, the access device is configured to perform the blocks of the operational flow.

In a block 360, the access device receives a request to add a new user object. In one embodiment, a user logs onto an existing user object and then enters the request to add the new user object via control device 138 (see, e.g., FIG. 2).

In a block 362, the access device is configured to determine whether an administrator attribute was enabled in the existing user object in which the user is logged onto. In one embodiment, the access device can check its own stored user object configurations to determine whether the user object has its administrator attribute enabled. If the existing user object does not have its administrator attribute enabled, the operational flow terminates because in this embodiment only administrators can add a new user object. If the existing user object does have its administrator attribute enabled, the operational flow proceeds to block 344.

As previously described in conjunction with FIG. 15, in block 344, the access device then receives default user object information for new user object that is being added. In one embodiment, the access device provisions the new user object with default information, which the access device displays to the user. Alternatively, the access device can be configured to prompt the user to enter the new user object information and skip down to block 352.

In blocks 346, 352, and 354 (also described above in conjunction with FIG. 15), the access device receives modifications to the default user object information, sends the new user object information to the server and receives one or more ticket numbers associated with the new user object information. In alternative embodiments, the request to add a user mode need not come via an access device. For example, a CSR can make the request and provide the new user mode information using a computer coupled to the server.

FIG. 17 illustrates one embodiment of revising a user object, according to the present invention. The operational flow starts with a user being logged onto an existing user object. In this example embodiment, the access device is configured to perform the blocks of the operational flow.

In a block 380, the access device receives a request to revise user object information for an existing logical object. In one embodiment, the user logged onto the existing user object makes the request to revise the existing logical object via control device 138 (see, e.g., FIG. 2). In this embodiment, the logical object is a user object. However, in light of the present disclosure, those skilled in the art can implement an operational flow for revising other logical objects without undue experimentation.

In a block 382, the access device determines whether an administrator attribute was enabled in the existing user object in which the user is logged onto. In one embodiment, the access device can be configured to check its own stored user object information to determine whether the “logged on” user object has its administrator attribute enabled. The request of block 380 can be to revise the “logged on” user object or another user object in the household. If the “logged on” user object does not have its administrator attribute enabled, the operation flow jumps to a block 386 (described below). In contrast, if the “logged on” user object does have its administrator attribute enabled, the operational flow proceeds to a block 383.

In block 383, the access device determines whether the request of block 380 is to revise a protected setting or settings of the exiting user object. For example, as previously described, some attributes can only be changed by an administrator (referred to in this context as a “protected setting”). If the request is not to revise a protected setting or settings, the operational flow proceeds to block 386 (described below). However, if the request is to revise a protected setting or settings, the operational flow proceeds to a block 384. In an alternative embodiment, block 383 may be performed before block 382.

In block 384, the access device can receive the revised setting or settings for the protected setting of the existing user object (e.g., the user object that is being revised). In one embodiment, the user enters the revised setting or settings via an input interface for the access device (e.g., control device 138 in FIG. 2).

In block 386, the access device can receive revised non-protected settings for the existing user object. As described in block 384 above, the user can enter the data via an input interface for the access device.

In one embodiment, blocks 383, 384 and 386 are performed concurrently. The access device may display all of the user object's information, for example, in a menu. The user can select settings to be revised. The access device is configured to determine whether the selected setting is protected. Non-protected settings can be revised by any “logged on” user object. If the setting is protected, the access device is configured to determine whether the “logged on” user object has its administrator attribute enabled before allowing the protected setting to be revised.

Alternatively, the access device can be configured to determine whether the “logged on” user object has its administrator attribute enabled. If enabled, the access device can display a menu with all of the settings (both protected or non-protected). If not enabled, the access device can be configured to display a menu with only non-protected settings. The user could then select and revise any of the displayed settings.

In a block 388, the access device provides to the server the revised user object information received in blocks 384 and 386. In one embodiment, the access device provides this information in a series of messages to the server. Alternatively, the access device can provide each piece of user object information to the server before prompting the user to enter the next piece of information. The operational flow then proceeds to block 354, which has been previously described in conjunction with FIG. 15.

In alternative embodiments, the request to revise a user mode need not come via an access device. For example, a CSR can make the request and provide the revised user mode information using a computer coupled to the server.

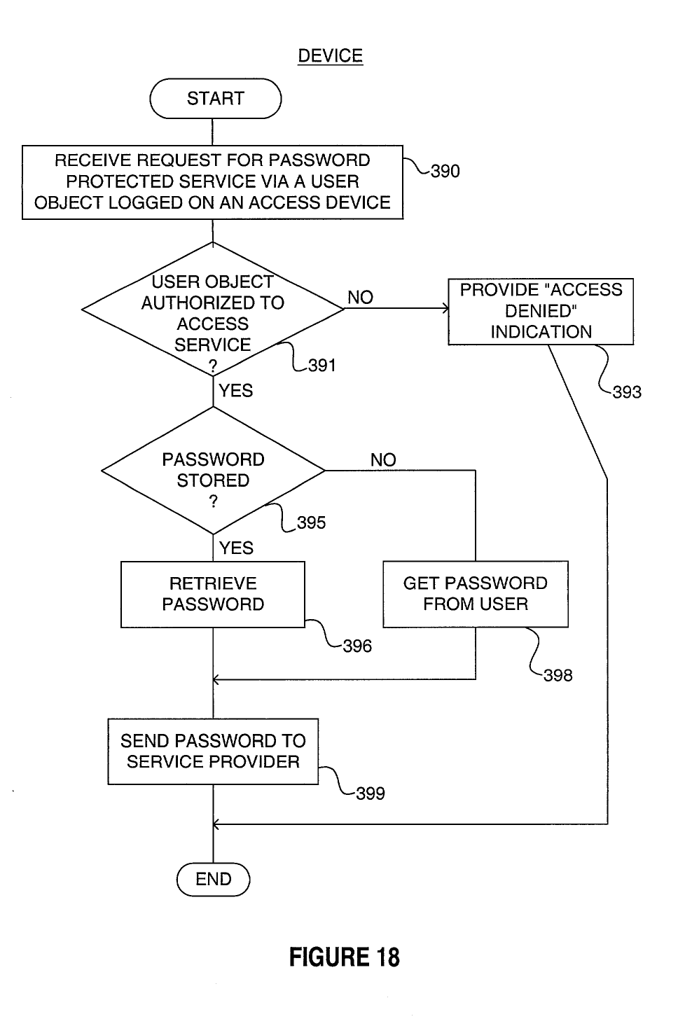

FIG. 18 illustrates one embodiment of using a single password protected logon for accessing multiple password-protected services, according to the present invention. In this embodiment, the operational flow starts with a user being logged onto an existing user object. In this example embodiment, the access device is configured to perform the blocks of the operational flow.

In a block 390, the access device receives a request to access a password-protected service (e.g., PPV, VOD, etc.). In one embodiment, the user logged onto the existing user object makes the request for the service via control device 138 (see, e.g., FIG. 2).

In a block 391, the access device determines whether the user object is authorized to access the service. For example, the user object may have been configured to deny access to the service because the service provides adult or violent content. If the user object is not authorized to access the service, the operational flow proceeds to a block 393.

In block 393, the access device provides an indication that the user object is not authorized to access the service, or that the requested access was denied, or other similar message. For example, the access device may display such message via display device 136 (see, e.g., FIG. 2).

However, if in block 391 the access device determines that the user object is authorized to access the service, the operational flow proceeds to a block 395. In block 395, the access device determines whether the password corresponding to the requested service and the user object is stored in the access device. This password may be part of the data associated with the access device object (see, e.g., Table 3 of Appendix A).

If the password is stored in the access device, the operational flow proceeds to a block 396. In block 396, the access device retrieves the password for the requested service from memory 166 (see, e.g., FIG. 3).

Conversely, if the password is not stored in the access device, in a block 398 the access device gets the password from the user. For example, the access device may perform a password challenge operation. This feature is useful because some services do not allow the password to be stored on the access device (e.g., access to a “wallet” service).

In a block 399, the access device then sends the password (either retrieved from memory 166 or inputted by the user in response to a password challenge operation) to the service provider. The service provider would then allow access to the service if the password were correct.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

For instance, while the term “household” is used herein to describe embodiments where the household comprises a home, it is to be appreciated that the term “household” can be used in analogous situations in other embodiments. For instance, a “household” can comprise a non-residence, such as a business or classroom, in some embodiments. In other embodiments, the access devices in a household need not necessarily be physically located within the same building. An example of this type of “household” is where some access devices are located within a building, while other access devices may be located outside of the building, such as with mobile wireless access devices. Accordingly, the invention is not to be limited by the specific location of any one of the access devices.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

### APPENDIX A

TABLE 1
USER OBJECTS

| | |
|---|---|
| User Name | Data that includes an identifier to which all user data |
| | and attributes are associated. The user name is unique |
| | and is used for logging in from access devices. In some |
| | embodiments, the user name can be associated with an |
| | email address. |
| User Password | Data that includes a password used to verify the identity |
| | of the user logging in. In one embodiment, the |
| | password is not retrievable by a user. |
| Administrator | An attribute that when enabled allows the user object to |
| | have administrative privileges. For example, when |
| | logged into a user object with the administrator attribute |
| | enabled, the administrator can change or add user |
| | object information for other user objects. |
| User Password | An attribute that when enabled, allows a user to access |
| Optional | a television account without a password. This attribute |
| | allows a user to view television but not to access other |
| | interactive television services. |
| User | Data that includes an identifier used to identify the |
| Household | household to which the user object is associated. |
| User Email | Data that includes an identifier representing the email |
| Address | address of the user object with regard to the interactive |
| | television system. In some embodiments, the user |
| | email address is the same as the user name. |
| Email Enabled | An attribute that when enabled allows the user object to |
| | access an email account. |
| Screen Name | Data associated with a user name that is displayed by |
| | the access device (for example a set top box). The |
| | screen name need only be unique within a household. |
| | In a further refinement, if the screen name is not set, the |
| | access device can default to displaying the user name. |
| Deleted | An attribute that when enabled deletes a user object |
| | from a household. The user objects data and attributes |
| | are not actually deleted, but are not accessible by a |
| | user. This attribute allows the interactive television |
| | service provider to resurrect the user object as desired. |
| Revision | Data used in keeping track of updates to the user object. |
| History | In one embodiment, the revision history includes entries |
| | for each update, each entry having at least a ticket |
| | number and a bit vector indicating which configuration |
| | perimeter has been updated. |
| Channel List | Data that includes the channels that are accessible via |
| | the user object. For example, a parent can create the |
| | channel list for a child with only channels that have no |
| | adult or violent content. In another embodiment, the |
| | channel list may also include a list of favorite channels, |
| | which are a subset of the accessible channels. |
| Persistent | Data that includes a list of cookies and associated |
| Cookies | information maintained on behalf of the user object. |
| Mail Data | A directory structure for mail folders and message data. |
| Web Favorites | Data containing a list of favorite web sites or web pages |
| | for the user object. |
| TV Favorites | Data containing a list of favorite television channels, in |
| | one embodiment, TV favorites are included in the |
| | channel list. |
| QWERTY | An attribute that when enabled displays an onscreen |
| Keyboard | keyboard in the QWERTY format rather than in |
| | alphabetical order. |
| Allow PPV | An attribute that when enabled, allows the user object to |
| | purchase pay per view events. |
| PPV PIN | Data that includes a user object's personal identification |
| | number for authorizing a PPV purchase. User object |
| | PPV PIN is optional. In an alternative embodiment, the |
| | PPV PIN associated with an access device. |
| Partner Login | Data that includes multiple user names and passwords, |
| | each user name and password being associated with a |
| | different interactive television service provider partner. |
| | This allows a user to log onto a user object with a single |
| | password and access services from partners without |
| | having to reenter a user name and password for that |
| | particular partner. |
| Login | A process that occurs when a user begins to log onto a |
| Challenge | user object from an access device registered with a |
| | household. The login challenge displays a list of screen |
| | names of all user objects registered in the current |
| | household for use when an access device displays a |
| | login challenge. When a user wishes to log on to a user |
| | object, the user selects his or her screen name from the |
| | displayed list and enters the password. |
| External Login | A process that occurs when a user attempts to access |
| Challenge | data from an access device that does not belong to the |
| | household. The external login challenge can also be |
| | used when the access device is not capable of |
| | recognizing what household it belongs to. In one |
| | embodiment, the external login challenge prompts the |
| | user to enter a user name and password. |
| Anonymous | Data that includes the attributes and data of an |
| User | anonymous user object. The anonymous user object is |
| | only available when watching full screen television and |
| | does not allow access to any interactive television |
| | service. The anonymous user object can be accessed |
| | by logging out and is the default state on power up. The |
| | anonymous user object inherits the common subset of |
| | restrictive attributes of all registered user objects in the |
| | household. |
| Logging Out | A process available to any logged in user object. The |
| | result of executing the logging out process is the logging |
| | in of the anonymous user. |
| Access Control | Data that includes a list of all privileges available to the |
| Lists | user object and a list of registered user objects. An |
| | administrator can edit the access control lists to control |
| | the privileges available to each registered user. |

TABLE 2
HOUSEHOLD

| | |
|---|---|
| Account ID | Data that includes a unique identifier for an account |
| | with an interactive television service provider. |
| Adding Users | A process that occurs to add a new user object to the |
| | household. Additional user objects can be added to the |
| | household as long as the number of user objects is less |
| | than a specified maximum number. Only an |
| | administrator can add a user object to a household. |
| Removing Users | A process that occurs to remove a user object from a |
| | household. The data and attributes associated with the |
| | user object are not removed, but the user object is |
| | “deleted” (see Table 1). The data and attributes of a |
| | deleted user object are not accessible by other users |
| | unless an administrator “un-deletes” the user object. |
| User List | Data that includes a list of registered users within a |
| | household. In one embodiment, the user list includes a |
| | list of user names. |
| Current User | Data that includes the current number of user objects |
| Count | registered in the household. This number will always |
| | be greater than zero and less than or equal to a |
| | maximum. |
| Maximum User | Data that includes the maximum number of user |
| Count | objects allowed in a household. |
| Household | Data that includes a unique identifier for the |
| Identifier | household. |

TABLE 3
ACCESS DEVICE

| | |
|---|---|
| Household | Data that includes the identifier of the household to |
| Identifier | which the access device belongs. |
| MAC Address | Data that includes the media access control (MAC) |
| | address of the device. |
| Default User | Data that identifies the user object to become active |
| Object | when the access device is first activated or turned on. |
| | In one embodiment, the first user object registered in the |
| | household is the default user object. If this first user |
| | object is password protected, then the anonymous user |
| | object becomes the default user object. In one |
| | embodiment, an administrator can designate any non- |
| | password protected user object in the household to be |
| | the default user object. |
| PPV PIN | Data that contains the personal identification number |
| | used for authorizing pay per view services. In one |
| | embodiment, the PPV PIN is stored in the access device |
| | and is not exposed to users. |
| Television | Data that includes a personal identification number for |
| Control PIN | locking and unlocking channels. |

TABLE 4
ACCOUNT

| | |
|---|---|
| MSO | Data that contains the name of the MSO (Multi- |
| | Service Operator) to which the account object |
| | is associated. |
| MSO Account ID | Data that contains the MSO account number to which |
| | the account object is associated. |
| Households List | Data that contains the number of household objects |
| | associated with the account object, and the household |
| | identifiers of these household objects. |
| Total Households | Data that contains the number of household objects in |
| | the account object. In one embodiment, this |
| | information is stored in the Households List. |
| Total Users | Data that contains the total number of user objects |
| | associated with the account object. |
| Total Access | Data containing the total number of access device |
| Devices | objects associated with the account object. |

What is claimed is:

1. A system to view multimedia content, the system comprising:
a broadcast center capable of being communicatively coupled to a network; and
a plurality of client systems coupled to the broadcast center,
wherein the plurality of client systems are associated with a household,
wherein the plurality of client systems are logical extensions of each other,
wherein the household is configurable to be associated with a plurality of user objects,
wherein a client system of the plurality of client systems is configured to be selectively accessed by a user to change a configuration of a user object of the plurality of user objects that is related to a favorites setting, and
wherein the system is configured to provide the change of the configuration of the user object related to the favorites setting to all of the client systems of the plurality of client systems without further activity from the user.

2. The system of claim 1 wherein the system is configurable to selectively add a new client system to the plurality of client systems, the system being configured to provide the plurality of user objects, including the favorites setting, to the new client system without activity from a user.

3. The system of claim 1 wherein a user object of the plurality of user objects can be concurrently active in more than one client system of the plurality of client systems.

4. The system of claim 1, further comprising a server operatively coupled to the plurality of client systems, wherein the server is configured to include information related to each user object of the plurality of user objects, including the favorites setting.

5. The system of claim 4 wherein the server is configured to include a revision history, the revision history being configurable to include information related to configuration changes of the plurality of user objects, including changes to the favorites setting.

6. The system of claim 5 wherein the revision history includes a ticket number associated with each configuration change that is included in the revision history.

7. The system of claim 4 wherein the server is capable to provide configuration changes to the plurality of client systems in response to a request for the configuration changes sent from at least one of the client systems.

8. The system of claim 4 wherein, independent of a request from any one of the client systems, the server is capable to provide configuration changes to the plurality of client systems if such configuration changes are received by the server from at least one of the client systems.

9. The system of claim 1 wherein the favorites setting includes an address associated with the network.

10. The system of claim 1 wherein the favorites setting includes a television channel.

11. A method to provide access to content in a multimedia communication network system having a plurality of access devices, the method comprising:
receiving configuration information related to a user object from a user via an access device of the plurality of access devices,
wherein the configuration information defines multimedia content that can be accessed by instantiating the user object in the access device,
wherein the configuration information further defines at least one favorites setting for that access device; and
providing the received configuration information, including the favorites setting, to another access device of the plurality of access devices.

12. The method of claim 11, further comprising:
receiving revised configuration information related to the user object via one of the access devices of the plurality of access devices, the revised configuration information including a revision to the favorites setting; and
providing the received revised configuration information, including the revision to the favorites setting, to all of the access devices of the plurality of access devices.

13. The method of claim 12, further comprising assigning a ticket number to the revised configuration information.

14. The method of claim 13, further comprising storing the ticket number in a revision history in a server of the multimedia communication network system.

15. A control system to provide access to content in a multimedia communication network system having a plurality of access devices, the control system comprising:
a server to receive configuration information related to a user object from a user via an access device of the plurality of access devices,
wherein the configuration information defines multimedia content that can be accessed via instantiation of the user object in the access device,
wherein the configuration information further defines at least one favorites setting for that access device, and
wherein the server is capable to provide the received configuration information, including the favorites setting, to another access device of the plurality of access devices.

16. The control system of claim 15 wherein the server is further capable to receive revised configuration information related to the user object via one of the access devices of the plurality of access devices, the revised configuration information including a revision to the favorites setting, and to provide the received revised configuration information, including the revision to the favorites setting, to all of the access devices of the plurality of access devices.

17. The control system of claim 16 wherein the server is capable to assign a ticket number to the revised configuration information and to store the ticket number in a revision history.

18. The control system of claim 16 wherein the server is capable to provide the revised configuration information including the revision to the favorites setting to the plurality of access devices in response to a request for the revised configuration information sent from at least one of the access devices.

19. The control system of claim 16 wherein, independent of a request from any one of the access devices, the server is capable to provide the revised configuration information including the revision to the favorites setting to the plurality of access devices if such revised configuration information is received by the server from at least one of the access devices.

20. An article of manufacture, comprising:
a machine-readable medium for use in a multimedia communication network having a plurality of access devices, the machine-readable medium having instructions stored thereon to:
receive configuration information related to a user object from a user via an access device of the plurality of access devices,
wherein the configuration information defines multimedia content that can be accessed via instantiation of the user object in the access device,
wherein the configuration information further defines at least one favorites setting for that access device; and
provide the received configuration information, including the favorites setting, to another access device of the plurality of access devices.

21. The article of manufacture of claim 20 wherein the machine-readable medium further includes instructions stored thereon to:
assign a ticket number to the revised configuration information; and
store the ticket number in a revision history in a server of the multimedia communication network system.

22. The article of manufacture of claim 20 wherein the machine-readable medium further includes instructions stored thereon to provide the revised configuration information including the revision to the favorites setting to the plurality of access devices in response to a request for the revised configuration information sent from at least one of the access devices.

23. The article of manufacture of claim 20 wherein the machine-readable medium further includes instructions stored thereon to provide, independently of a request from any one of the access devices, the revised configuration information including the revision to the favorites setting to the plurality of access devices if such revised configuration information is received from at least one of the access devices.

24. The article of manufacture of claim 21 wherein the configuration information includes values for a plurality of configuration parameters, at least one of the configuration parameters being related to the favorites setting, the machine-readable medium further including instructions stored thereon to:
set a bit in a bit vector, the bit vector having a plurality of bits each being associated to a corresponding configuration parameter of the user object, wherein the set bit indicates the configuration parameter associated with the received configuration information and is related to the favorites setting; and
provide the bit vector to one of the access devices.

24. An update method to provide configuration information related to user object of a multimedia communication network system having a plurality of access devices, the configuration information including values for a plurality of configuration parameters, at least one of the configuration parameters being related to a favorites setting, the method comprising:
receiving a portion of the configuration information including the favorites setting via an access device of the plurality of access devices;
assigning a ticket number to the received portion of the configuration information;
storing the ticket number in a revision history; and
providing the ticket number to the access device.

25. The update method of claim 24, further comprising:
setting a bit in a bit vector, the bit vector having a plurality of bits each being associated to a corresponding configuration parameter of the user object, wherein the set bit indicates the configuration parameter associated with the received configuration information and is related to the favorites setting; and
providing the bit vector to the access device.

26. The update method of claim 25, further comprising providing the portion of the configuration information to a second access device of the plurality of access devices.

27. An article of manufacture, comprising:
a machine-readable medium for use in a multimedia communication network system having a plurality of access devices, the configuration information including values for a plurality of configuration parameters, at least one of the configuration parameters being related to a favorites setting, the machine-readable medium having instructions stored thereon to:
receive a portion of the configuration information including the favorites setting via an access device of the plurality of access devices;
assign a ticket number to the received portion of the configuration information;
store the ticket number in a revision history; and
provide the ticket number to the access device.

28. The article of manufacture of claim 27 wherein the machine-readable medium further includes instructions stored thereon to:
set a bit in a bit vector, the bit vector having a plurality of bits each being associated to a corresponding configuration parameter of the user object, wherein the set bit indicates the configuration parameter associated with the received configuration information and is related to the favorites setting; and
provide the bit vector to the access device.

29. The article of manufacture of claim 27 wherein the machine-readable medium further includes instructions stored thereon to provide the portion of the configuration information to a second access device of the plurality of access devices.

30. A method to provide configuration information for at least one user object to an access device in a multimedia communication network system having a server and a plurality of access devices, the access devices of the plurality of access devices being associated with one or more households, the method comprising:
receiving a signal at the server that an access device is being associated with a household in response to user activation of the access device when the access device is coupled to the multimedia communication network system;
sending from the server an indication of whether the access device is the household's first access device; and
sending from the server configuration information for at least one user object when the access device is not the first access device of the household, the configuration information sent from the server including a favorites setting present in at least one of the other access devices in the household.

31. The method of claim 30, further comprising:
receiving configuration information from the user, including another favorites setting, via the access device when the access device is the first access device of the household; and
providing to the server the configuration information received from the user.

32. The method of claim 31, further comprising sending from the server a ticket number corresponding to the configuration information provided to the server.

33. An apparatus to coordinate settings to access content available via an interactive video casting system having a plurality of channels, the interactive video casting system having connectivity to a plurality of access devices and capable to provide the plurality of access devices with access to a communication network, the apparatus comprising:
a server located in the interactive video casting system and capable to communicate with each access device in the plurality of access devices via a communication protocol suitable to each access device,
wherein the server is capable to receive configuration information related to a user object from a user via one of access device of the plurality of access devices according to the communication protocol for that access device,
wherein the configuration information defines multimedia content that can be accessed via instantiation of the user object in the access device,
wherein the configuration information further defines at least one favorites setting for that access device,
wherein the at least one favorites setting includes an address associated with a location in the communication network where the content can be accessed by the access device or including a channel among the plurality of channels of the interactive video casting system,
wherein the server is capable to provide the configuration information received from the access device, including the favorites setting having the address or the channel, to another access device of the plurality of access devices without further activity from the user according to a communication protocol suitable to that access device.

34. The apparatus of claim 33 wherein, independent of a request from any one of the access devices, the server is capable to provide the revised configuration information including the revision to the favorites setting to the another access devices if such revised configuration information is received by the server.

35. An apparatus to coordinate settings to access content available via an interactive video casting system having a plurality of channels, the interactive video casting system having connectivity to a plurality of access devices and capable to provide the plurality of access devices with access to a communication network, the apparatus comprising:
a server located in the interactive video casting system and capable to communicate with each access device in the plurality of access devices via a communication protocol suitable to each access device,
wherein the server is capable to receive configuration information related to a user object from a user via one of access device of the plurality of access devices according to the communication protocol for that access device,
wherein the configuration information defines multimedia content that can be accessed via instantiation of the user object in the access device,
wherein the configuration information further defines at least one favorites setting for that access device,
wherein the at least one favorites setting includes an address associated with a location in the communication network where the content can be accessed by the access device or including a channel among the plurality of channels of the interactive video casting system,
wherein the server is capable to provide the configuration information received from the access device, including the favorites setting having the address or the channel, to another access device of the plurality of access devices without further activity from the user according to a communication protocol suitable to that access device, the server further being capable to:
assign a ticket number to a portion of the received configuration information;
store the ticket number in a revision history;
provide the ticket number to the access device that sent the configuration information;
set a bit in a bit vector, the bit vector having a plurality of bits each being associated to a corresponding configuration parameter of the user object, wherein the set bit indicates the configuration parameter associated with the received configuration information and is related to the favorites setting; and
provide the bit vector to the access device that sent the configuration information.

36. The apparatus of claim 35 wherein, independent of a request from any one of the access devices, the server is capable to provide the revised configuration information including the revision to the favorites setting to the another access devices if such revised configuration information is received by the server.

37. An apparatus to provide access to content in a multimedia communication network system having a plurality of access devices, the method comprising:
a means for receiving configuration information related to a user object from a user via an access device of the plurality of access devices,
wherein the configuration information defines multimedia content that can be accessed by instantiating the user object in the access device,
wherein the configuration information further defines at least one favorites setting for that access device; and
a means for providing the received configuration information, including the favorites setting, to another access device of the plurality of access devices.

38. A system to provide configuration information for at least one user object to an access device in a multimedia communication network having a server and a plurality of access devices, the access devices of the plurality of access devices being associated with one or more households, the system comprising:
a means for receiving a signal at the server that an access device is being associated with a household in response to user activation of the access device when the access device is coupled to the multimedia communication network;
a means for sending from the server an indication of whether the access device is the household's first access device; and
a means for sending from the server configuration information for at least one user object when the access device is not the first access device of the household, the configuration information sent from the server including a favorites setting present in at least one of the other access devices in the household.
